(19) United States
(12) Patent Application Publication
(10) Pub. No.: US 2005/0228838 A1
(43) Pub. Date: Oct. 13, 2005

(54) Processing technique for digital speckle photogrammetry

(76) Inventors: Karl Andrew Stetson, Coventry, CT (US); Mark Barry Rosenthal, Arlington, MA (US)

Correspondence Address: Karl A. Stetson, 2060 South Street, Coventry, CT, 06238, US

(21) Appl. No.: 10/409,713

(22) Filed: Apr. 10, 2003

(51) Int. Cl. G06F 7/00

(52) U.S. Cl. 708/200

(57) ABSTRACT

An improved numerical technique is disclosed for processing digital photo-graphs for measuring surface strain by speckle photogrammetry. The data to be processed is obtained by recording two digital photographs of speckle patterns of the image of the surface of an object where one photograph is recorded before a stress is applied and the other recorded afterward. In the case of a vibratory stress, the recordings are made by illuminating the object stroboscopically first at one extreme of its vibration cycle for the first photograph and then at the other extreme for the second photograph. Each photograph is divided into sectors and digital Fourier transforms are performed on each sector. The phase of these transforms is calculated for each image sector on both photographs, the resulting phase functions from the unstressed recording are subtracted from the corresponding phase functions on the stressed recording, and the results wrapped into a numerical range of −pi to plus pi. The slopes in the x and y directions of the resulting difference functions are calculated for each sector and related by a scale factor to the displacement of the speckles in that sector of the recording. The x and y speckle displacements in the neighboring sectors forming two-by-two arrays are subtracted to obtain relative speckle displacements from which to calculate x strain, y strain, shear, and rotation about the surface normal.

### REFERENCE

1. Robert K. Erf, (Ed.), Speckle Metrology, Academic Press, New York, 1978.
2. K. A. Stetson and I. R. Harrison, “Determination of the Principal Surface Strains on Arbitrarily Deformed Objects via Tandem Speckle Photography,” Proc. 6th Int. Conf. on Exp. Stress Analysis (Munich, 18-22 Sep. 1978, VDI-Verlag GmbH, Dusseldorf) 149-154.
3. K. A. Stetson and G. B. Smith “Heterodyne Readout of Specklegram Halo Fringes,” Appl. Opt., 19 (1980) 3031-3033.
4. K. A. Stetson, “Speckle and Its Application to Strain Sensing,” Proc. SPIE Vol. 353 (1983) 12-18.
5. K. A. Stetson, “The Use of Heterodyne Speckle Photogrammetry to Measure High Temperature Strain Distributions,” Proc. SPIE, Vol. 370 (1983) 46-55.
6. K. A. Stetson, “A Heterodyne Optical Strain Sensor,” Proc. 29th Intern. Instru. Symp., ISA, May 1983, pp.65-70.
7. Mikael Sjödahl, “Digital Speckle Photography” in Digital Speckle Pattern Interferometry and Related Techniques, P. K. Rastoji, (Ed.), J. Wiley & Sons, New York, 2001, Chap. 5.
8. J. M. Huntley, “Automated Analysis of Speckle Interferograms” in Digital Speckle Pattern Interferometry and Related Techniques, P. K. Rastoji, (Ed.), J. Wiley & Sons, New York, 2001, Chap. 2, pp. 89-95.

### TECHNICAL FIELD

This invention relates to digital speckle photogrammetry and, more particularly, to an improved digital processing technique for extracting subpixel displacements from digital photographs of speckle patterns for the purpose of calculating strain.

### BACKGROUND ART

When a diffusely reflecting object is illuminated by laser light and observed by a lens system, the resulting image has a speckled texture due to the random interference of light reflected by the microstructure of the object. It was noticed in the late 1960s that, when an object surface was in focus, the speckles moved as if attached to the object surface and that photographic recordings of these speckles could be used to measure object surface displacements. During the 1970s, this technique developed into a practical method of measurement of object displacements called speckle photography, and this technique is comprehensively described in Reference 1 cited above. As this technology evolved, various applications were proposed to use it to measure strain, which may be defined as the fractional elongation of materials due to stress. Reference 2 above describes a technique involving the recording of pairs of speckle photographs, positioned in tandem, and comparing the relative speckle movements at common points to determine the complete strain and rotation matrix for an object surface.

It was learned in the work of Ref. 2 that the main difficulty with such applications was the lack of accuracy with which speckle displacements could be measured. The common technique employed was to illuminate a small region of the specklegram (i.e. the speckle photograph) with a narrow, converging beam of laser light and observe the diffracted light (usually called the halo) in the plane where the illuminating beam came to focus. A double exposure specklegram in which the speckle pattern was translated between exposures, when thus illuminated, generates fringes within the halo pattern whose spacing is inversely proportional to the speckle displacement. This analysis technique is based upon the Fourier transform relationship between the transmittance function of a beam of coherent light and the diffraction pattern it scatters at the focus of such a beam. The main problems with this analysis method are that at least one fringe is needed for such an analysis and that there are limits on the accuracy with which the spacing of the fringes in such a pattern can be measured.

In order to overcome the limitations of halo fringe analysis of specklegrams, a heterodyne technique was developed as described in reference 3 above. In this technique, separate specklegram recordings were made for each of two states of an object, one before and one after stress was applied. The two specklegrams were then placed in separate beams of an interferometer and their halos combined by means of a beamsplitter to create interference fringes. In such an apparatus, it is possible to introduce an optical frequency shift into one of the interfering beams and cause the halo interference fringes to travel across the field of view. Photodetectors placed in such a pattern will generate sinusoidal signals that can be evaluated by an electronic phase meter that can measure phase to 0.1 degree. Changes in fringe spacings are thereby converted into changes in electronic phase, and such a system has the accuracy needed for practical strain measurement, as described in references 4-6.

The analysis of photographic specklegrams by an interferometric photocomparator is, none-the-less, slow, costly, and dependent upon photographic recordings. For that reason, applications of heterodyne speckle photogrammetry focused mainly on static high-temperature strain measurements where other methods were generally not available. As such, this technique has not seen widespread use. Regardless of that, the field of speckle photogrammetry has remain ed active, and new technology has resulted in the development of a digital form of this technology called digital speckle photogrammetry, which is described comprehensively in reference 7. The technique of digital speckle photogrammetry involves the numerical processing of digital photographs of speckle patterns and also dates back some 20 years. These techniques involve tracking the movements of digitally recorded speckle patterns by numerically correlating sectors of one recording with those of another, again where the two recordings are before and after some stress is applied to an object. Whereas these techniques are very effective for measurement of large values of strain, they do not have the degree of displacement resolution and dynamic range associated with optical heterodyne speckle photogrammetry.

### DISCLOSURE OF INVENTION

This invention consists of a numerical processing procedure that extracts object displacements from digital speckle photographs to an accuracy that is a small fraction of the pixel (picture element) size of the digital photograph. The numerical procedure is analogous to the optical procedure used in heterodyne speckle photogrammetry, but is carried out solely by numerical methods.

According to the present invention, digital photographs are recorded of a speckle pattern observed on the surface of the object before and after some stress is applied to the object. The camera used to record these speckle photographs is positioned so as to be aligned parallel to the object surface normal. In the case that strain is required on a vibrating object, the object is illuminated stroboscopically so as to capture its position first at one extreme of its vibration cycle and then at the other extreme. The camera is chosen to provide a digital output of the irradiance values of its pixels to an accuracy of 12 bits or better. The images are stored as data files in a digital computer. It is important to note that the speckle pattern used for this process may be either a speckle pattern created by illumination with laser light, or a so called white light speckle pattern created by some actual reflecting structure on the object such as droplets of paint, toner powder, or retroreflecting beads, etc. It must also be noted that the lens system used with the camera system recording these speckle patterns must be designed to provide a telecentric image wherein all points on the object are observed from the same direction, so as to eliminate apparent changes in magnification due to translations of the object toward the camera. The processing of these images then consists of the following steps:
1. The images are divided into sectors, for example but not limited to, 256 by 256 pixels. As an example, an image containing 1300H by 1030V pixels would generate 20 sectors by such a division.
2. A two-dimensional digital Fourier transform is performed on each sector of each photographic recording, and the phase of each resulting transform is calculated for each element in the output transform. These phase arrays are random variables of the coordinates of the transforms and range from minus pi to plus pi.
3. The phase functions of the sector transforms for the undeformed speckle photograph are subtracted from the phase functions of the sector transforms for the deformed speckle photograph. The results, which will extend from −2 pi to +2 pi, are wrapped into a range of minus pi to plus pi. This wrapping operation means that any value below minus pi has 2 pi added to it, and any value above pi has 2 pi subtracted from it.
4. The resulting difference arrays are evaluated for their slopes in the two spatial frequency coordinates of the transform, and these slopes are related by a scale factor to the displacement of the speckles within the common sectors of the two recordings. The determination of the scale factor is described in Appendix 1.
5. The speckle displacements for two-by-two arrays of sectors are evaluated mathematically to calculate the surface strain and in-plane rotation for the set of four sectors as described in Appendix 2.

It is not obvious how this procedure allows the measurement of speckle displacements that are smaller than the pixel size of the recording. That this is possible can be seen from consideration of the fact that the speckle pattern recorded can be decomposed into various sinusoidal patterns of various frequencies, each of which contributes to a component in the Fourier transform of the total pattern. Each sinusoidal component in the speckle pattern is sampled by the pixel array in a manner akin to what is called spatial phase stepping.⁸ This means that each pixel integrates the irradiance of a sector of the sinusoidal pattern for a sector of its wavelength. It is possible to calculate, from such a sampling, the phase of the sinusoidal pattern, and this will, in fact, be the phase of the component of the Fourier transform corresponding to that spatial frequency. A shift of the speckle pattern as a whole shifts each of these sinusoidal components by the same distance and this constitutes an increasing fraction of the cycle as the spatial frequency increases. Thus a shift alters the phase of these sinusoidal components in an amount proportional to the spatial frequency of these components. Thus, the greater the displacement, the more rapid the increase in phase of Fourier transform as a function of spatial frequency. Since the measurement of this phase change is made in a manner equivalent to phase stepping, the accuracy with which subpixel displacements can be calculated depends upon the accuracy with which the pixel irradiances measured by the digital camera. If the irradiance measurements made by the digital camera are resolved to 12 bits, then the phase can be measured, in theory, to one part in 4096.

This reasoning also provides an indication of a limitation to be imposed on the use of the Fourier transform array for calculating the slope of a phase difference function and thus the displacement. Given an input array of N-by-N values, a digital Fourier transform will generate an output transform also containing values ranging from −N/2 to +N/2, each of these corresponding to a spatial frequency value. When the magnitude of the index in the output array exceeds N/4, however, aliasing occurs with regard to the phase measurement, because too few pixels are being used to sample each spatial frequency component. Therefore, the slope of the transform phase difference array must be calculated only from those values within a circle of radius N/4.

Appendix 1—Calculation of Scaling Constant for Speckle Displacement

The calculation of the digital Fourier transform may be described by the equation
F(j,k)=Σ_{m=0 to m-1}Σ_{n=0toN-1}f(m,n) exp[−i2π(jm/M+kn/N)], (1)
where:
f(m,n) is the function of which the transform is being calculated,
m and n are the pixel indices in the x and y directions,
M and N are the number of pixels in the x and y directions of the sector considered,
j and k are the indices of the coordinates of the transform, and
F(j,k) is the Fourier transform of f(m,n) with respect to the variables j and k.

A displacement of one pixel in the x direction for the function f(m,n) will generate a phase function in the transform plane whose slope is 2π/M and a displacement in the y direction of one pixel will generate a phase function whose slope is 2π/N. If sⱼ and sₖ are the measured slopes in the j and k directions in the transform plane, then the corresponding displacements, dₓ and d_{y} are
dₓ=pₓsⱼM/2π, and (2)
d_{y}=p_{y}sₖN/2π, (3)
where pₓ and p_{y} are the pixel spacings in the x and y directions.
Appendix 2—Calculation of Strain from Pixel Displacements

Identify four sectors in a rectangular array and indicate them by the subscripts shown below.
11 12
21 22

The average relative displacements of these sectors may be defined as:
Δₓₓ=(dₓ₁₂−dₓ₁₁+dₓ₂₂−dₓ₂₁)/2 (4)
is the average x expansion in the x direction.
Δ_{yy}=(d_{y11}−d_{y21}+d_{y12}−d_{y21})/2 (5)
is the average y expansion in the y direction.
Δ_{xy}=(dₓ₁₁−dₓ₂₁+dₓ₁₂−dₓ₂₂)/2 (6)
is the average x expansion in the y direction.
Δ_{yx}=(d_{y12}−d_{y11}+d_{y22}−d_{y21})/2 (7)
is the average y expansion in the x direction.

Given the fact that the sectors are separated in x by M pixels and in y by N pixels, the x strain, y strain, and shear are defined as:
εₓₓ=Δₓₓ/pₓM (8)
ε_{yy}=Δ_{yy}/pₓN (9)
ε_{xy}=(Δ_{yx}/pₓM+Δ_{xy}/p_{y}N)/2 (10)

When Eqs. (2) and (3) are substituted into Eqs. (4)-(7), and the results substituted into Eqs. (8)-(10), it is seen that the factors of pₓM and p_{y}N cancel from the strain calculations.

Equations (8)-(10) may be rewritten in terms of the measured fourier transform plane slopes as
εₓₓ=(sₓ₁₂−sₓ₁₁+sₓ₂₂−sₓ₂₁)/4π (11)
ε_{yy}=(s_{y11}−s_{y21}+s_{y12}−s_{y22})/4π (12)
ε_{xy}=(sₓ₁₁−sₓ₂₁+sₓ₁₂−sₓ₂₂+s_{y12}−s_{y11}+s_{y22}−s_{y21})/4π (13)

1. A numerical method for processing digital speckle photographs for the purpose of strain measurement comprising of:
recording speckle photographs of an object under laser illumination, before and after stress is applied, by means of a digital camera whose pixel irradiance values may be digitized to a suitable number of binary bits, such as, but not limited to 12 bits,
dividing the speckle photograph into sectors of, but not limited to, 256 by 256 pixels,
computing the two-dimensional digital Fourier transforms of these sectors and calculating the phase of the elements of said Fourier transforms,
subtracting, for corresponding object sectors, the phase values of the Fourier transforms of the speckle pattern corresponding to the undeformed object from those corresponding to the deformed object,
wrapping the resulting phase difference values into the range of −pi to +pi by adding the value of 2 pi to any values that lie below −pi and subtracting 2 pi from any values lying above +pi,
fitting for least square error a linear function in two dimensions to the resulting wrapped phase difference values over a range not exceeding a circle with radius of N/4 element values in the Fourier transform plane,
where N is the number of values in either of the two dimensions of the Fourier transform,
determining the slope of this linear function in each dimension and multiplying it by a scale factor to convert it to displacement of the speckles between the unstressed and stressed conditions, said scale factors being described in Appendix 1 of this patent,
subtracting the displacements of neighboring sectors in 2 by 2 arrays to obtain relative displacements of the object surface sectors, and
combining these relative displacements to calculate the x strain, y strain, shear, and rotation characterizing the deformation of the 2 by 2 array of sectors as described in Appendix 2 of this patent.

2. The process described in claim 1 wherein the speckle pattern used to characterize the object is a random pattern of real reflective material such as paint droplets, toner particles, or retroreflective beads illuminated by incoherent light.

3. The process described in claim 1 wherein the image of the object is magnified or demagnified relative to the object itself in the recording process.

4. The process described in claim 1 wherein the imaging system used in the photography of the object is telecentric so as to observe all object points from the same direction and to eliminate apparent magnification of the image due to displacement of the object toward or away from the camera.

5. The process described in claim 1 wherein the camera is aligned parallel to the surface normal of the object being recorded.
